(19) United States
(12) Patent Application Publication
(10) Pub. No.: US 2009/0180617 A1
(43) Pub. Date: Jul. 16, 2009

(54) Method and Apparatus for Digital Rights Management for Removable Media

(75) Inventor: Petr Peterka, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/972,433

(22) Filed: Jan. 10, 2008

(51) Int. Cl. H04L 9/06

(52) U.S. Cl. 380/277

(57) ABSTRACT

A process is provided. The process determines member devices in a domain of devices. Further, the process encrypts a set of content with a content encryption key to generate an encrypted set of content. In addition, the process encrypts the content encryption key with each of a plurality of pre-fetch keys to generate a plurality of encrypted content encryption keys. Each of the pre-fetch keys corresponds to a member device in the domain of devices. Finally, the process stores each of the encrypted content encryption keys in a content license corresponding to a member device in the domain of devices. The encrypted content may be stored on a removable medium. Further, the process allows another device to play back the content from the same removable medium.

### BACKGROUND

1. Field

This disclosure generally relates to the field of audio/visual content. More particularly, the disclosure relates to the management of rights associated with audio/visual content.

2. General Background

A digital rights management (“DRM”) system may allow content owners and service providers to deliver content in a secure manner so that the content owner's rights are protected and business models and contracts enforced while simultaneously providing end-users with seamless content consumption controls. Further, the DRM system may provide a mechanism for importing content from a different secure domain, re-encrypting that content uniquely for the receiving device, persistently storing that content, sharing the content within the domain, and exporting that content at a later time to another security domain. The secure domain includes a limited number of devices that are securely bound to the domain. For content that is explicitly allowed to be shared within the user's secure domain, the DRM system may provide the ability to securely stream or copy persistently stored content from the initial receiving device to another device that has been authenticated as part of that customer's personal network (e.g., Internet Protocol (“IP”) network), which is also called the secure home domain. For example, this allows sharing of content between a digital video recorder (“DVR”) and a set-top box (“STB”), or a DVR and a mobile handset that are all registered as part of the same user domain.

The DRM system may be based on a combination of asymmetric cryptography, e.g., Public Key Infrastructure (“PKI”), and symmetric cryptography, e.g., algorithms utilizing AES and/or 3DES. The DRM system may be based on Kerberos (RFC 1510) and the use of X.509 certificates (RFC 3280.

When two end points want to securely stream or copy content between them, a secure session is established which includes a set of symmetric keys that both end points share and use to encrypt, decrypt, and authenticate individual packets or messages. This portion of the DRM system employs symmetric cryptography, so that latency and server loading are minimized during session set-up. The secure session is utilized to communicate control and rights information, as well as key exchange. Encrypted content is transmitted over a separate channel which supports multiple file-based and streaming formats.

The DRM system supports the concept of the home domain, which is a collection of DRM devices identified specifically within the user's home where content may be shared. The content usage rules determine the circumstances under which the consumer may make one or more copies of such content or render it on such multiple in-home devices. In order to fully enforce content usage rules, DRM requires authentication of all devices within the home network. At least one of the devices is typically capable of authenticating with an external server.

The same content rights that apply to the content stored on a persistent storage device (e.g. DVR, handset, etc.) also apply to the other devices in the DRM domain. For example, if the content is to expire after some period of time, the rule has to be enforced on each device that is a member of the home domain. In the case that a device is not able to maintain secure time, then that device would then be given a one-time rendering of the content without an ability to store a local copy. In general, if a device is not capable of enforcing all of the relevant DRM rules, its access to stored content will be more restricted. There are also additional rules defined specifically for the DRM domains.

The DRM system typically distributes content decryption keys on demand. This means that when a receiving device wants to consume a piece of content, it requests the corresponding key with associated rights from the source device (e.g., DVR) just before the content is streamed or copied. Other DRM systems sometime create a license that is bound to the content that can be freely moved from one device to another. Such licenses are protected with a domain key, which ensures that only devices that have been previously provisioned into the domain will be able to process the license and subsequently consume the content. Using a single shared domain key limits not only the security of the system, but also the flexibility in deciding which domain devices can or cannot share the domain content utilizing removable media. Accordingly, current approaches do not efficiently provide for transferring data to a removable media for use in a portable device in a home network.

### SUMMARY

In one aspect of the disclosure, a process is provided. The process determines member devices in a domain of devices. Further, the process encrypts a set of content with a content encryption key to generate an encrypted set of content. In addition, the process encrypts the content encryption key with each of a plurality of pre-fetch keys to generate a plurality of encrypted content encryption keys. Each of the pre-fetch keys corresponds to a member device in the domain of devices. Finally, the process stores each of the encrypted content encryption keys in a content license corresponding to a member device in the domain of devices.

In another aspect of the disclosure, a computer program product is provided. The computer program product comprises a computer useable medium having a computer readable program. The computer readable program when executed on a computer causes the computer to determine member devices in a domain of devices. Further, the computer is caused to encrypt a set of content with a content encryption key to generate an encrypted set of content. In addition, the computer is caused to encrypt the content encryption key with each of a plurality of pre-fetch keys to generate a plurality of encrypted content encryption keys. Each of the pre-fetch keys corresponds to a member device in the domain of devices. Finally, the process stores each of the encrypted content encryption keys in a content license corresponding to a member device in the domain of devices.

In yet another aspect of the disclosure, a system is provided. The system includes a member analysis module that determines member devices in a domain of devices. Further, the system includes an encryption module that encrypts a set of content with a content encryption key to generate an encrypted set of content and encrypts the content encryption key with each of a plurality of pre-fetch keys to generate a plurality of encrypted content encryption keys. Each of the pre-fetch keys corresponds to a member device in the domain of devices. Finally, the system includes a storage module that stores each of the encrypted content encryption keys in a content license corresponding to a member device in the domain of devices.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a DRM system which provides DRM protection for a removable medium for use in a domain.

FIG. 2 illustrates a process that may be utilized to provide DRM protection for the removable medium for use in the domain shown in FIG. 1.

FIG. 3 illustrates a system configuration that may be utilized to register client devices in the domain.

FIG. 4 illustrates a system configuration that may by a client device to request a PFK.

FIG. 5 illustrates a block diagram of a station or system that provides DRM protection for a removable medium for use in a domain.

### DETAILED DESCRIPTION

A method and apparatus are provided in a DRM system to support a transfer of content that is bound to a domain of devices, e.g., a DVR recording, to a removable media, e.g., a DVD, such that the content can be consumed later by another DRM device. Access to the content is limited to devices that are registered in the same domain.

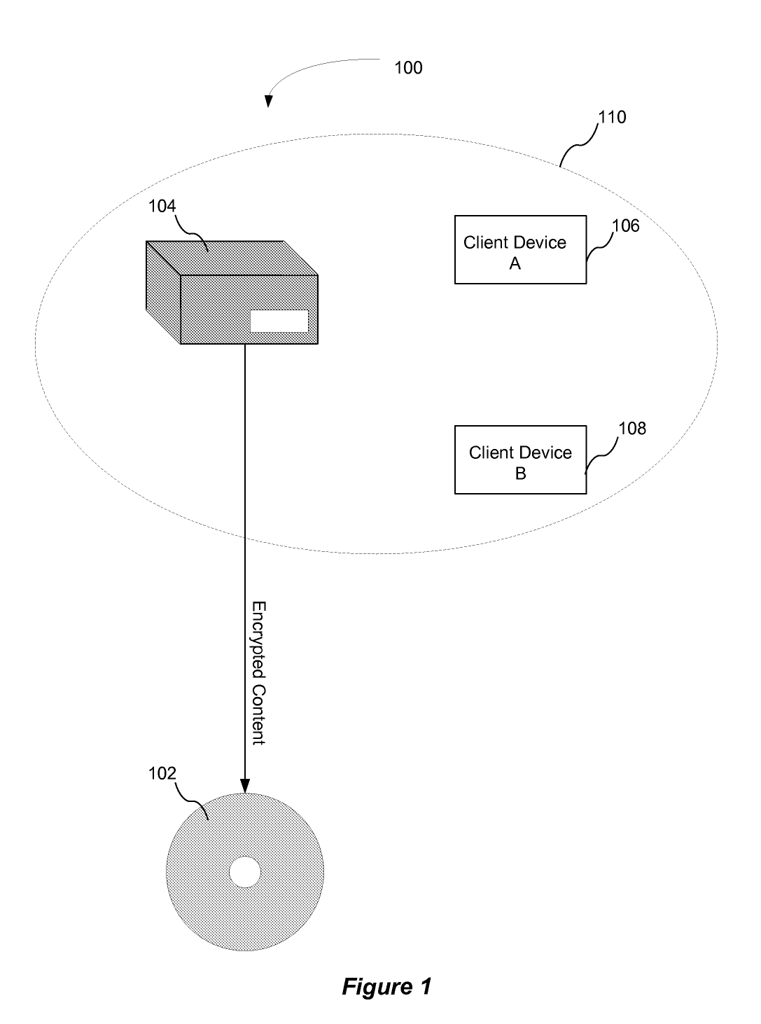

FIG. 1 illustrates a DRM system 100 which provides DRM protection for a removable medium 102 for use in a domain 110. The removable medium 102 may be a DVD, flash memory, removable non-volatile memory, portable hard drive, etc. In one implementation, a source device 104, e.g., a DVR, can copy or move persistent content to the removable medium 102, with or without reencryption. A specific client device, e.g., a client device A 106 or a client device B 108, may request access to some or all content ahead of time such that the content may be transferred via the removable medium 102 without additional connectivity to the source device 104 at the time of consumption. Each client device possesses a specific pre-fetch key (“PFK”) not shared with any other member of the domain. Accordingly, each license is issued specifically for each member of the domain. As a result, each piece of content on the removable medium can be consumed by all enabled devices. Each client device only has to request the PFK just once. Therefore, the source device 104 may put additional content on the removable medium for the client device without specifically requesting that content at the time of obtaining the PFK. This provides more convenience to the end user than specifying each set of content explicitly. Optionally, the PFK may have an expiration time. Therefore, the client device refreshes its PFK after the previous version expires.

A single copy of the content may be stored irrespective of how many domain devices may have access to it. The content encryption key (“CEK”) is protected in the corresponding license(s) by the PFK. If more than one device is to access the content, multiple copies of the license are utilized with different unique PFK for each client device. Alternatively, all devices may share the same PFK, called the shared domain key (“SDK”).

When devices join a domain, e.g., a home domain, the devices may be identified as being capable of accepting content on different types of removable media, e.g., DVD, flash memory, etc. Such devices may subsequently request access to removable content.

A domain controller, e.g., a Home Key Distribution Center (“KDC”) will create a unique key for removable media associated with each device capable of processing removable media, i.e., utilizing a PFK. Each member of the domain may request this key and be granted the right to use it based on its capabilities, e.g. having a DVD drive or a memory slot. Such attributes may be provided by the client device in its certificate or outside of the security protocols using Universal Plug and Play (“UPnP”)/Digital Living Network Alliance (“DLNA”) protocols. Issuing different PFKs to each device allows each PFK to be associated with additional restrictions specific to a device. For instance, the device may be prevented from further copying the content onto another DVD even if allowed by the content DRM rules or Copy Control Information (“CCI”).

The removable media key has two derivatives: (1) the removable media key encryption key (“KEK”), which is the Pre-Fetch KEK (“PF-KEK”) and (2) the removable media license authentication key (“LAK”), which is the Pre-Fetch LAK (“PF-LAK”). The KEK is used to decrypt the content decryption key stored in the license while the LAK is used to verify the integrity of the license itself.

The PFK may be periodically expired. The old key remains valid, but would not be utilized to protect new license files on removable media. Accordingly, a PFK ID is listed in the license and identifies the specific version of that key being used.

In one implementation, the domain controller may periodically create a new PFK for each device. As a result, several removable media are each associated with a different PFK, which may cause potential confusion and require all devices to store a large number of PFKs. Alternatively, a hash chain mechanism may be utilized. For instance, a series of keys is chained such that a device needs to remember only the most recent one and is able to derive the older ones. As an example, a server may define a hash chain K1, K2=H(K1), K3=H(K2), . . . KN=H(KN−1) and pre-computes the whole chain for a large number of keys. Then it starts out by making the removable media key equal to KN. Later, the server changes the key to KN−1 and gives that one out instead. Anyone that has KN−1 can also compute KN=H(KN−1) and so would be able to decrypt older content files having a license encrypted with KN, etc. Each device (except for the server that pre-computed the whole chain) would need to keep track of only the latest removable media key and can derive the older keys from it as needed.

In one implementation, the DRM system 100 may include two subsystems for content sharing. In particular, the DRM system 100 may have a provisioning and ticket management subsystem, and a key management subsystem.

The Ticket Management subsystem is primarily represented by the Key Distribution Center (“KDC”). The KDC has two components: (1) Authentication Service (“AS”) for authentication of users and granting of the initial ticket, and (2) Ticket Granting Service (“TGS”) for issuing tickets for specific services. The main function of the KDC is to keep track of all the provisioned clients and servers in a system and the cryptographic data associated with them. Additionally, the KDC authenticates clients and issues tickets for those clients to use as trusted tokens during client server communications. The KDC assigns expiration time to tickets requiring clients to periodically renew them. By allowing clients to temporarily cache these tickets, the DRM system 100 eliminates transactions to the KDC before each request of content decryption keys from content servers.

In one implementation, a device can also be provisioned into a home network, with a simplified version of the KDC (called “Home KDC”) that would normally be resident on a device that has been designated as a “media hub”. A device being provisioned into the home network receives a ticket for the media hub, allowing it to: (1) request content to be streamed or copied from the media hub; (2) request content to be streamed or copied from another content server in the same domain; or (3) copy content obtained from a service provider outside of the home network into the media hub or another content server in the domain. This enables the content to be shared with all other devices registered in this user's domain.

In one implementation, the source device 104 has the KDC. In an alternative implementation, the KDC is a device separate from the source device. In that instance, the source device 104 communicates with the KDC to obtain information such as a list of the devices within the domain 110 and their corresponding PFKs.

A client device and the media hub establish secure sessions for transferring content using the same key management protocol that is also used to establish secure sessions between a device and a content server that is external to the user's domain (i.e. obtaining content from the infrastructure), or between devices within the user's home domain. In order to establish a secure session for the content, the destination device must obtain from the media hub both a decryption key and the corresponding set of content rights that will be stored persistently in the form of a content license. Further, the key management protocol provides a set of transactions such as a key request transaction and an AS request transaction as utilized by the DRM system 100. Alternatively, a similar transaction called TGS request may be used. The key request is a transaction derived from the Kerberos Application Request (“AP REQ”) to make it suitable for a DRM system.

For example, the DRM system 100 may allow for an AS request transaction to request a ticket for a removable medium service rather than requesting a ticket for a specific server by specifying a server principal name. To implement this approach, the client devices persistently store tickets containing the PFK. Tickets have generally long expiration times and do not have to be refreshed often. The expiration of the ticket can coincide with the expiration of the PFKs or the SDK such that a client device needs to obtain a new ticket only when a new PFK or SDK is issued.

Alternatively, the client device could extract the removable media key from the ticket and store it persistently (e.g. similar to a content license) such that content stored on a removable medium does not expire even when the associated ticket does. Such content expires only when the device leaves the domain. For example, when a device leaves the domain, to join another one, the device cannot use the PFK or SDK while it is not registered to the original domain.

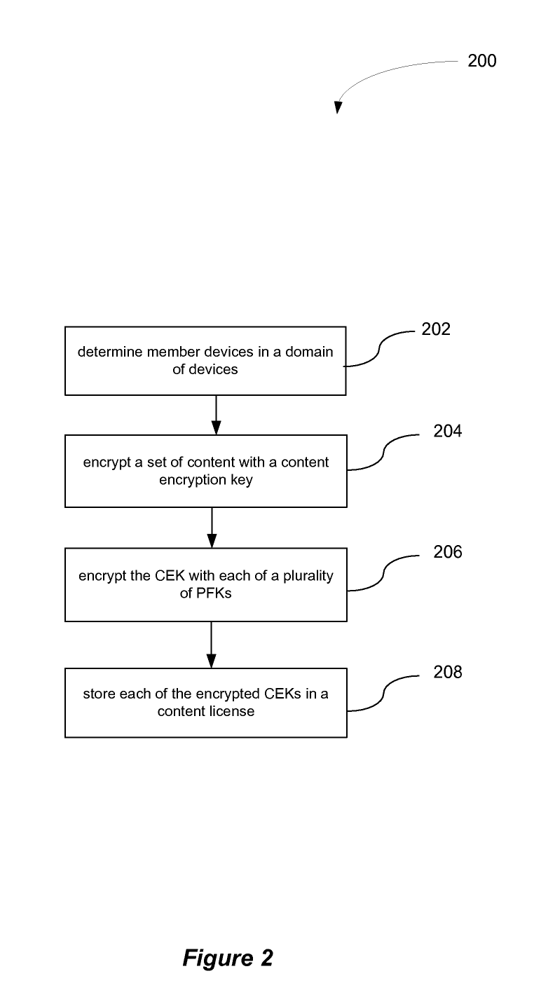

FIG. 2 illustrates a process 200 that may be utilized to provide DRM protection for the removable medium 102 for use in the domain 110 shown in FIG. 1. At a process block 202, the process 200 determines member devices in a domain of devices. The devices in the domain may be capable of processing content on removable media. For example, the source device 104 may obtain a list of registered devices in the domain of devices. In one implementation, the client device is registered at a Home KDC. Before a server device, e.g., the source device 104, or a client device, e.g., client device A 106 or client device B 108, can request a PFK, the KDC, e.g., the Home KDC, creates a list of PFKs in its server database. This can be done at the time when a new device capable of processing removable media gets provisioned by the Home KDC. Further, at a process block 204, the process encrypts a set of content with a content encryption key to generate an encrypted set of content. In one implementation, the content encryption key is unique. In addition, at a process block 206, the process 200 encrypts the CEK with each of a plurality of pre-fetch keys to generate a plurality of encrypted content encryption keys. Each of the pre-fetch keys corresponds to a member device in the domain of devices. Finally, at a process block 208, the process 200 stores each of the encrypted content encryption keys in a content license corresponding to a member device in the domain of devices. In one implementation, the process 200 also stores the corresponding content DRM rules and/or CCI in each of the content licenses corresponding to the distinct member devices in the domain of devices. In yet another implementation, the encrypting of the content may be executed at a different time (e.g., the time the content is recorded on a DVR) than the removable medium content license creation time. More specifically, the CEK is encrypted with an encryption key derived from the PFK (i.e., the PF-KEK) and the license is signed using a signing key derived from the PFK (i.e., PF-LAK).

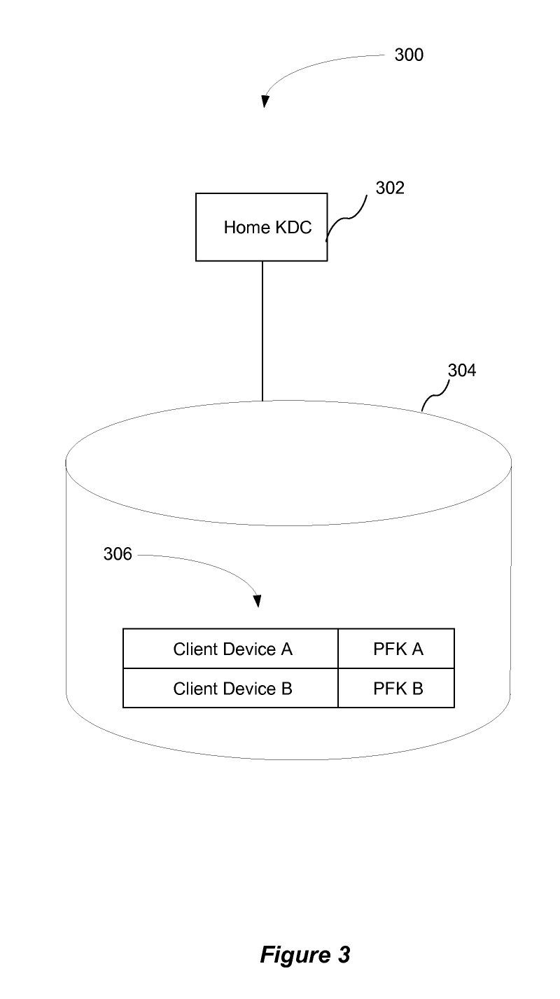

FIG. 3 illustrates a system configuration 300 that may be utilized to register client devices in the domain. In particular, a Home KDC 302 is in operable communication with a server database 304. The Home KDC 302 utilizes the server database 304 to maintain a list 306 of devices in the domain 110, as shown in FIG. 1, and the corresponding PFK for each device. For example, the list 306 of devices may include client device A 106 and client device B 108 as shown in FIG. 1. Further, the list 306 of devices may indicate the PFK for client device A 106 is PFK_{A} and the PFK for client device B 108 is PFK_{B}. Optionally, the Home KDC may associate further permissions or constraints with each device (e.g., based on its capabilities).

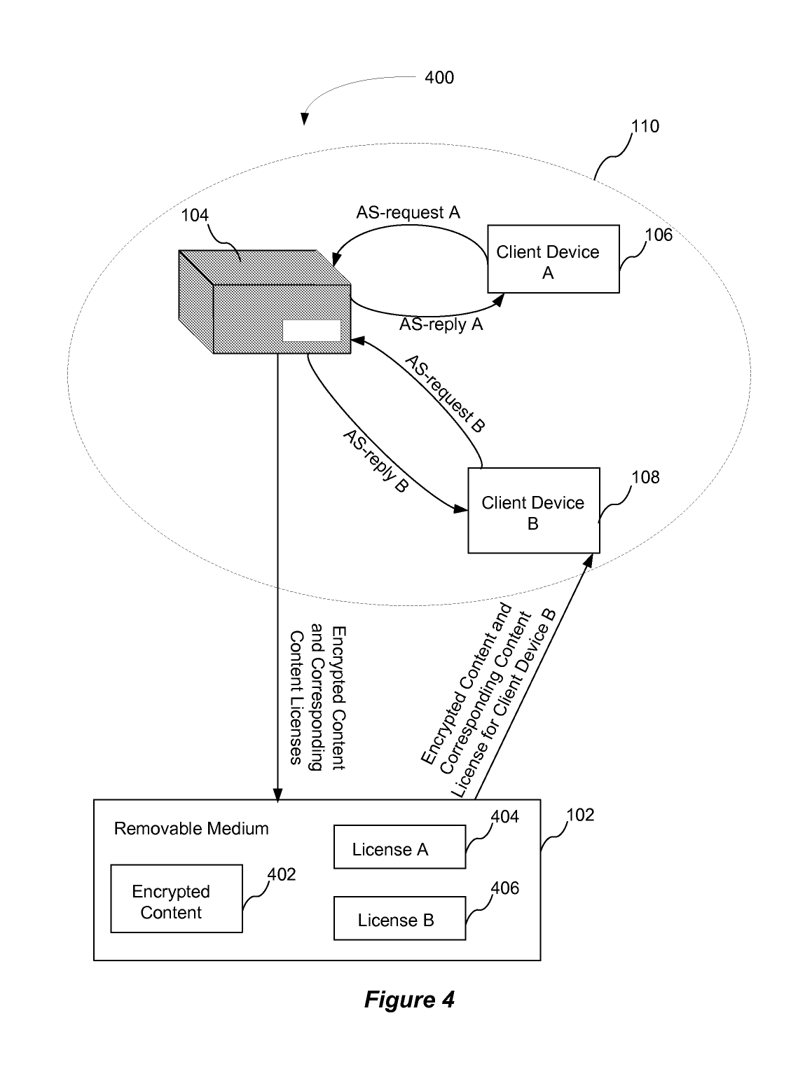

FIG. 4 illustrates a system configuration 400 that may by a client device to request a PFK. In one implementation, each client device capable of processing removable media requests the PFK utilizing the AS request and the Removable Medium Service as the server name. If the source device 104 that writes the content to the removable medium 102 is not the Home KDC, the source device 104 requests the PFKs for all portable devices that should have access to the content. For example, an application request to copy content to a removable medium may include a list of device names for which to create a license. The source device 104 may remember the list of all device PFKs, or the source device 104 may request it when needed.

The source device 104 creates a license protected with the PFK for each client device as described in process 200. Further, the source device 104 puts the license on the removable medium 102 together with the encrypted content. In addition, the license indicates that it is protected by a specific PFK. For example, when copying a piece of content to the removable medium 102, the source device 104 encrypts a single copy of the content with the CEK. The source device 104 then copies the encrypted content 402 to the removable medium 102. Although only one encrypted copy of the content is copied to the removable medium 102, a separate license for each member of the domain 110 is also copied to the removable medium. For example, a license A 404 corresponding to the client device A 106 is copied to the removable medium 102 in addition to a license B 406 corresponding to the client device B 108.

Each of the client devices performs an AS-request to obtain its respective PFK to utilize the corresponding license. The AS-request may be performed before or after content is stored on removable media. For example, client device A 106 makes an AS-request A to the source device 104 for PFK_{A}. The source device 104 then provides an AS-reply A to client device A 106 with the removable media ticket containing the PFK_{A}. Further, client device B 108 makes an AS-request for PFK_{B}. The source device 104 then provides an AS-reply B to client device A 106 with the PFK_{B}. In one implementation, tickets in a key management protocol are utilized in the transactions between the client devices and the source device. For example, the PFK may be sent through a ticket. Alternatively, the TGS transaction may be used for this purpose.

Multiple pieces of encrypted content may be copied from the source device 104 to the removable medium 102. Each piece of encrypted content need only be copied once to the removable medium 102. However, for each piece of encrypted content, the license for each device in the domain 110 is also copied from the source device 104 to the removable medium 102. Each license may contain the content identifier, the PFK identifier, the encrypted CEK, the DRM rules, and/or CCI and a signature.

In one implementation, if more than one set of content is on the removable medium 102, the same PFK is utilized. In another implementation, if multiple removable media are created, the same PFK may be utilized for each user.

As a result, a client device only stores a PFK and does not need to store a license. Further, the AS-request and AS-reply transactions only need to be performed once for each device or once during the PFK lifetime.

In an alternative implementation, a KEY-request transaction may be utilized to deliver the PFK. The device would issue a regular KEY-request with a removable medium key identifier (“PFK ID”) instead of a specific content ID. Each device will create a local license, but instead of identifying a piece of content that the license is associated with, the license will be identified as associated with removable media access. If removable media keys have expiration time associated with them, the license will have the same expiration and the client device requests the new version of these keys at that time. If the source device 104 is not the KDC, then the source device 104 also requests the PFKs from the KDC before creating licenses and storing them on the removable medium 102.

Some content licenses may be stateful such that there may be some restriction on playback of the content. In other words, a stateful license does not allow the user to play back the content any time that he or she wants to do so. For example, a stateful license may specify a counted playback, limited number of copies, or limited number of moves. When a client device consumes one of these rights, the client device must then update the license accordingly to ensure that these rules are consistently enforced over time as played by different devices. The updated license must be replaced on the removable medium.

To avoid content reencryption, the new license could be re-bound to the content by including a hash of the license or a license version number in the computation of the content hash, assuming the content includes a hash function based message authentication code (“HMAC”). The content header may also have an HMAC for this purpose. This mechanism may be utilized for re-writable media as opposed to write-once media. Thus, the DRM system 100 may disallow storing content with stateful licenses on write-once media.

To limit an attack where a user makes a bit-by-bit copy of a removable medium before consuming the rights and then trying to use the older copy, devices could persistently store a list of <content-id, license version number> pairs, similar to the remaining rights concept implemented by the DRM system 100 for regular licenses already. Such device would reject a license of a lower version number than previously consumed.

A particular piece of content or a class of content (e.g. all content received from a cable service) may be restricted by proximity. The client device is required to be in proximity either (1) at the time of requesting access to the PFK or SDK; or (2) at the time of a playback. The first case is already handled by the proximity option in the current key management protocol transactions, e.g., the KEY-request or AS-request.

The second option would require the CEK in the license to be protected with a key unknown to the client device which would make the client device request the key from the source device 104 just before the playback. This request could be utilized to measure the proximity. The client device utilizes the KEY-request to send the encrypted CEK back to the source device 104 for decryption. Once the source device 104 decrypts the key, it protects the key utilizing the normal KEY-reply protection mechanism. The source device 104 must be identified in the license. The key not being protected with the removable media key, but rather with the source device key, is also indicated in the key structure of the license. The license is authenticated using the removable media key.

In an alternative implementation, a source device 104 that is not the domain controller may be utilized. The content decryption key may be protected by the service key associated with the source device 104 which acts as a server. Since the domain controller, e.g., Home KDC, issued the service key to the source device 104, it is capable of decrypting the removable medium content key without communicating with the source device 104. Therefore, the source device principal name is indicated in the license.

In yet another implementation, a license is not included on the removable medium at all. Only the content ID and the device name, e.g., principal name, of the source device 104 are indicated to request the CEK from just before playback.

The process 200 shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

A computer is herein intended to include any device that has a general, multi-purpose, or single purpose processor as described above. For example, a computer may be a STB, cell phone, portable video player, or the like.

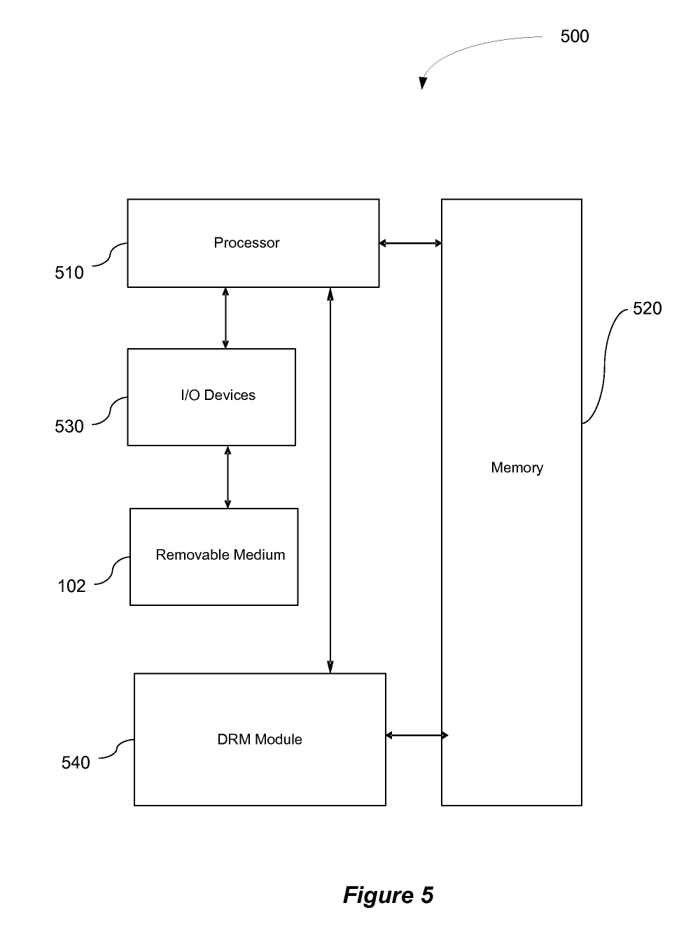

FIG. 5 illustrates a block diagram of a station or system 500 that provides DRM protection for a removable medium 102 for use in a domain 110. In one embodiment, the station or system 500 is implemented using a general purpose computer or any other hardware equivalents. Thus, the station or system 500 comprises a processor 510, a memory 520, e.g., random access memory (“RAM”) and/or read only memory (ROM), a DRM module 540, the removable medium 102 as shown in FIG. 1, and various input/output devices 530, (e.g., e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the DRM module 540 may be implemented as one or more physical devices that are coupled to the processor 510. Alternatively, the DRM module 540 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 520 of the computer. As such, the DRM module 540 (including associated data structures) of the present disclosure may be stored on a computer readable medium, e.g., RAM memory, magnetic or optical drive or diskette and the like.

It is understood that the DRM approach described herein may also be applied in other types of systems. Further, other DRM mechanisms than those described herein may be utilized to authenticate devices and distribute PFK keys. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

I claim:

1. A method comprising:
determining member devices in a domain of devices;
encrypting a set of content with a content encryption key to generate an encrypted set of content;
encrypting the content encryption key with each of a plurality of pre-fetch keys to generate a plurality of encrypted content encryption keys, each of the pre-fetch keys corresponding to a member device in the domain of devices; and
storing each of the encrypted content encryption keys in a content license corresponding to a member device in the domain of devices.

2. The method of claim 1, further comprising storing the encrypted set of content and the content license corresponding to each distinct member device on a removable medium.

3. The method of claim 2, wherein the removable medium is a Digital Video Disc.

4. The method of claim 2, wherein the removable medium is a non-volatile memory.

5. The method of claim 2, further comprising receiving a request from at least one of the member devices for the corresponding pre-fetch key.

6. The method of claim 5, further comprising authenticating that the member device is in the domain of devices and providing the pre-fetch key to the at least one authenticated member device.

7. The method of claim 5, wherein the at least one member device obtains the pre-fetch key prior to the encrypted set of content.

8. The method of claim 7, wherein the at least one member device, without being connected to a network, obtains the encrypted content and the content license corresponding to the member device from a removable medium.

9. The method of claim 8, wherein the pre-fetch key is utilized by the member device to decrypt the content encryption key obtained from the content license corresponding to the at least one member device.

10. The method of claim 9, wherein the content encryption key is utilized by the at least one member device to decrypt the encrypted set of content.

11. A computer program product comprising a computer useable medium having a computer readable program, wherein the computer readable program when executed on a computer causes the computer to:
determine member devices in a domain of devices;
encrypt a set of content with a content encryption key to generate an encrypted set of content;
encrypt the content encryption key with each of a plurality of pre-fetch keys to generate a plurality of encrypted content encryption keys, each of the pre-fetch keys corresponding to a member device in the domain of devices; and
store each of the encrypted content encryption keys in a content license corresponding to a member device in the domain of devices.

12. The computer program product of claim 11, wherein the computer readable program when executed on the computer further causes the computer to store the encrypted set of content and the plurality of distinct content licenses on a removable medium.

13. The computer program product of claim 12, wherein the removable medium is a Digital Video Disc.

14. The computer program product of claim 12, wherein the removable medium is a non-volatile memory.

15. The computer program product of claim 12, wherein the computer readable program when executed on the computer further causes the computer to receiving a request from at least one of the member devices for the corresponding pre-fetch key.

16. A system comprising:
a member analysis module that determines member devices in a domain of devices;
an encryption module that encrypts a set of content with a content encryption key to generate an encrypted set of content and encrypts the content encryption key with each of a plurality of pre-fetch keys to generate a plurality of encrypted content encryption keys, each of the pre-fetch keys corresponding to a member device in the domain of devices; and
a storage module that stores each of the encrypted content encryption keys in a content license corresponding to a member device in the domain of devices.

17. The system of claim 16, wherein the removable medium is a Digital Video Disc.

18. The system of claim 16, wherein the removable medium is a non-volatile memory.

19. The system of claim 16, further comprising a reception module that receives a request from at least one of the member devices for the corresponding pre-fetch key.

20. The system of claim 19, further comprising an authentication module that authenticates that the at least one member device is in the domain of devices and providing the pre-fetch key to the at least one authenticated member device.
